(19) United States
(12) Patent Application Publication
(10) Pub. No.: US 2005/0118990 A1
(43) Pub. Date: Jun. 2, 2005

(54) METHOD FOR AUDIBLE CONTROL OF A CAMERA

(75) Inventor: Debra K. Stephens, Cary, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/707,265

(22) Filed: Dec. 2, 2003

(51) Int. Cl. H04M 3/00

(52) U.S. Cl. 455/418

(57) ABSTRACT

A combination mobile phone and digital camera in which the digital camera can be controlled through audio or voice control. The mobile phone includes at least one microphone to detect audible input. Detected audible input is converted to an electrical signal and sent to a processor. The processor has access to a storage medium that contains software that causes the processor to operate on the detected audible input. The processor compares the detected audible input to a database of camera commands to determine if the detected audible input matches one of the camera commands in the database. If there is a match, the processor executes a set of instructions associated with the camera command to carry out the desired function.

### BACKGROUND OF INVENTION

Mobile phones today include sophisticated hardware and software designed to enhance the user experience. One of the more popular features of newer mobile phones is an integrated camera or attachable camera accessory. The ability to take and share a picture on a whim has appealed to mobile phone consumers. Sharing a picture taken by a mobile phone has become an easier task with the robust data applications now found on most mobile phones. Relatively high speed data connections to the Internet or other mobile phones are now standard features on most mobile phones. This makes it easier than ever to take and send a picture from one mobile phone to another mobile phone or to an Internet e-mail address. While advancements in mobile phone camera features has been impressive, the user is still required to manually operate the camera function as well as manually compose and send a picture to a remote destination.

Taking a picture is typically accomplished by manually actuating the camera function via a specified sequence of key strokes. Moreover, the user is precluded from appearing in most pictures because of the need to operate the camera. There may be wired or wireless controls to assist in the operation of the camera but these require keeping up with yet another mobile phone accessory.

What is needed is a means for operating the camera function of a mobile phone using voice commands. Voice commands do not require the use of a separate accessory and can allow the user greater flexibility in the taking and sending of pictures.

### SUMMARY OF INVENTION

The present invention can be characterized as a combination mobile phone and digital camera in which the digital camera can be controlled through audio or voice control. The digital camera can either be integrated into the mobile phone or attachable as an accessory to the mobile phone. Since the essence of the invention centers on voice control, the mobile phone includes at least one microphone to detect audible input. The microphone may be the microphone already resident on and used by the mobile phone to carry out a conversation. Or, the microphone can be an additional microphone integrated into the mobile phone or camera accessory to be used specifically for camera control purposes.

Detected audible input is converted to an electrical signal and sent to a processor. The processor has access to a storage medium that contains software that causes the processor to operate on the detected audible input. The processor compares the detected audible input to a database of camera commands to determine if the detected audible input matches one of the camera commands in the database. If there is a match, the processor executes a set of instructions associated with the camera command to carry out the desired function.

Database camera commands represent many functions including, but not limited to, taking a picture, storing a picture, deleting a picture, composing a message with the picture as an attachment, and adjusting the camera settings (e.g., flash, zoom, etc. . . . ). Each database command is associated with coded instructions that cause the processor to carry out the desired function.

### BRIEF DESCRIPTION OF DRAWINGS

FIG. 1 illustrates a front view of a mobile phone that has a camera function.

FIG. 2 illustrates a rear view of a mobile phone that has a camera function.

FIG. 3 is a flowchart describing a process for audibly controlling a camera or camera accessory that is associated with a mobile phone.

FIG. 4 is a flowchart describing a process for recognizing an audible command intended to operate the camera or camera accessory.

FIG. 5 is a flowchart describing a process for performing or executing a recognized camera command.

### DETAILED DESCRIPTION

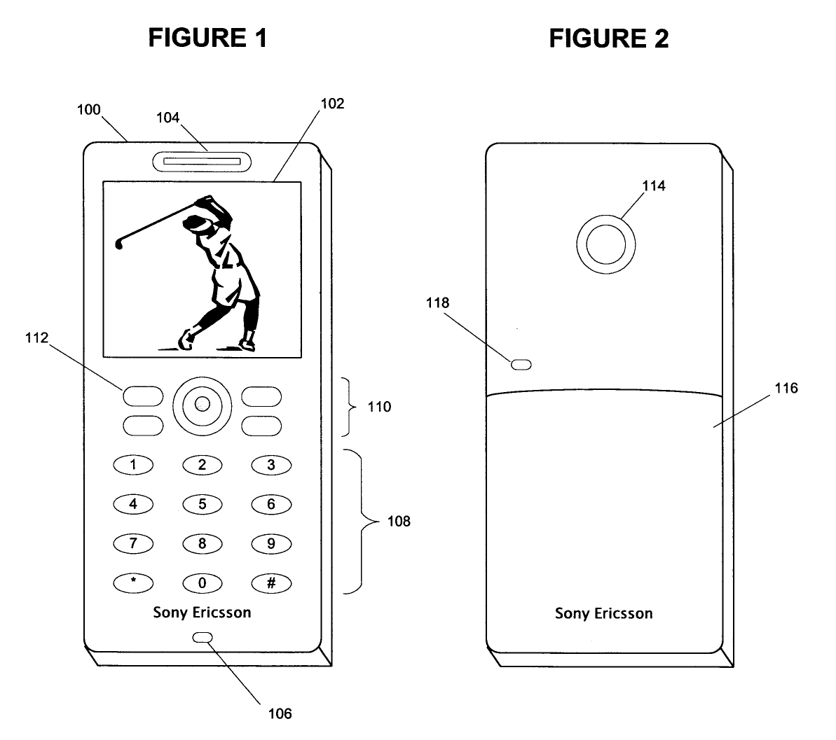

FIG. 1 illustrates a front view of a mobile phone having a camera function. In this illustration, a mobile phone 100 is shown having a display area 102. The mobile phone also includes such other elements and features as a speaker 104, microphone 106, standard numeric keypad 108, and special purpose keys 110 that control one or more aspects of the mobile phone. One of the special purpose keys can act as a shutter release button 112 that is capable of taking a picture.

FIG. 2 illustrates a rear view of the mobile phone shown in FIG. 1. In this embodiment, the mobile phone and camera are integrated into a single unit. Other mobile phones can function with a camera accessory that can attach to the mobile phone. For purposes of the present invention, whether the camera is integrated into the mobile phone or attachable to the mobile phone as an accessory is irrelevant since the invention focuses on controlling the camera and not the camera per se. The rear of the mobile phone 100 includes a lens 114, a battery cover 116, and a second microphone 118. The lens 114 orientation shown in FIG. 1 is illustrative only. The lens could be oriented differently, such as, for instance, on the front of the mobile phone or as a separate accessory that attaches to the mobile phone.

Microphone 118 can be optional and its orientation on the mobile phone is not to be considered limited to what appears in FIG. 2. The purpose of microphone 118 is to detect audible commands intended to operate the camera. It is entirely possible that microphone 106 shown in FIG. 1 can also accommodate the present invention in addition to its primary responsibility of picking up audio to be transmitted in a voice call.

Not shown are the internal processing elements that link and control the various external features. A processor and a processor readable storage medium are coupled together internally. Instructions, in the form of code recorded in the processor readable storage medium, cause events to occur based on the instruction set being invoked. There can be additional storage media accessible to the processor for storing data such as digital pictures taken by the camera. This storage can also hold phonebook or contact list data to assist in sending pictures from the mobile phone to other destinations. The contact list data can be stored elsewhere, for example, on a web-site so long as the processor can access the data to assist in composing a message.

In standard operation of the camera integrated into the mobile phone, the user uses the display 102 as a viewfinder while pointing the lens 114 at the target of the picture. Thus, the lens 114 faces the target while the user can coordinate the shot by viewing the display 102. The user typically grips the mobile phone in one hand pointing the lens 114 at the target. The user's thumb (or another finger) can rest on the shutter button 112 while the shot is lined up. When the user is satisfied with the shot as indicated in display 102, she can depress the shutter button 112 and take a picture. All of the steps described above require manual manipulation of the mobile phone to take a picture.

Once the picture has been taken, the user can decide what to do with the picture. Some of the options include deleting, storing, and/or sending the picture to one or more destinations/recipients. These functions are typically performed by the user using the keypad and display prompts. Sending the picture further requires the user to access her contact list to select which recipients to send the picture or manually enter the requisite contact data.

A goal of the present invention is to provide an alternative method for performing the above described (and other) tasks that does not require as much direct user manipulation of the mobile phone. This may be accomplished using audible control of the camera function and other features associated with the taking and sending of pictures by the mobile phone. Audible control alleviates the need to manually manipulate the mobile phone to achieve a desired result.

Audible control has been implemented on some mobile phones for purposes of assisting the user in dialing out, primarily as a convenience and/or safety feature that allows the user to operate the mobile phone in a ‘hands free’ manner. The present invention applies similar techniques to control operation of the camera and tasks associated with the camera such as manipulating camera settings, recorded images, and performing tasks. In addition, audible control can be implemented to use speech recognition wherein only one authorized user will be able to give audible commands, or without speech recognition wherein the mobile phone will accept input from multiple users or allow differing functions to be performed for the same words.

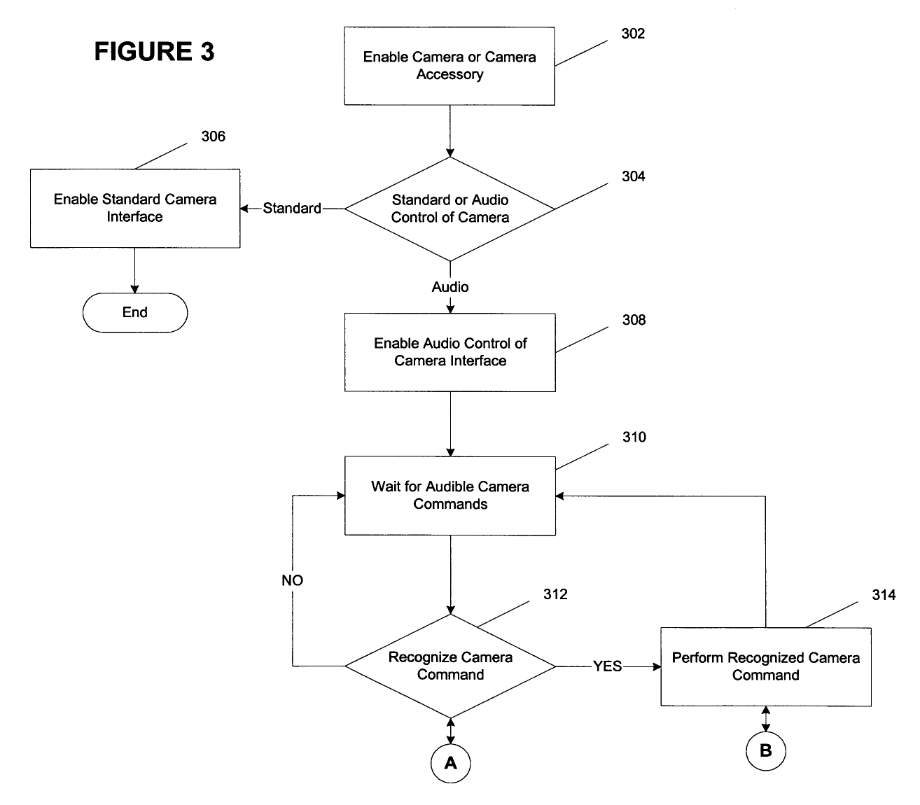

FIG. 3 is a flowchart describing a process for audibly controlling a camera or camera accessory associated with a mobile phone. The first step, illustrated in box 302, is enabling or activating the mobile phone camera or camera accessory. Although typically this is achieved by actuating a switch, button, or key on the mobile phone, this step may also be voice activated by issuing a ‘camera on’ command provided the mobile phone is already set to receive audible commands. The mobile phone can then prompt the user via a display message whether the user wishes to operate the camera in standard mode or in audio control mode as illustrated in decision box 304. If the user selects to operate the camera in standard mode, the standard camera interface is activated 306 and the user manually manipulates the keys to operate the camera. Otherwise, the camera is set for audible control 308 and goes into a wait state 310 while it attempts to detect audible commands. Each time the microphone detects an audible input it is processed by decision box 312 which determines if the audible command is a recognized camera command. If the results of decision box 312 are negative, the camera returns to the wait state described in box 310. If the results of decision box 312 are positive, then the camera performs the recognized camera command as indicated in box 314.

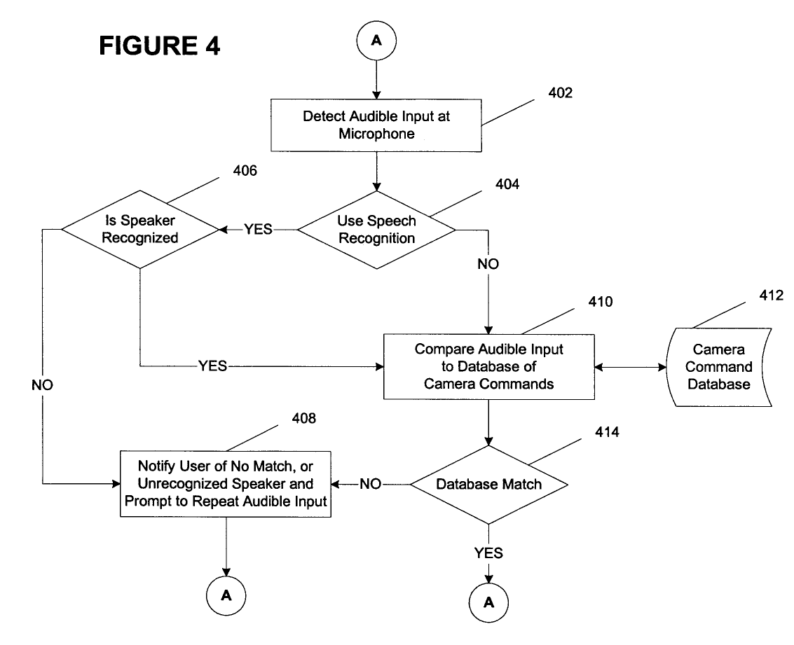

FIG. 4 is a flowchart describing a process for recognizing an audible command intended to operate the camera or camera accessory. This sub-process is spawned by decision box 312 of FIG. 3. To recognize a camera command, the mobile phone first detects audible input at a microphone 402. The process then checks whether a speech recognition option has been invoked 404. If speech recognition is active the detected audible input is processed to determine if the speaker is recognized 406. If the speaker is not recognized, the mobile phone indicates this to the user and asks the user to repeat the command 408. Control is then returned to the wait state of box 310 in FIG. 3. If the speaker is recognized, the next step is to compare the detected audible input 410 to a database of camera commands 412. This step is also executed if speech recognition was not invoked in box 404. A decision box 414 determines if there is a database match between the detected audible input and an entry in the database of camera commands 412. If no match is found, the mobile phone indicates such to the user and asks the user to repeat the command 408. If a match is found then control is returned to the main process illustrated in FIG. 3 where the recognized command is set to be executed.

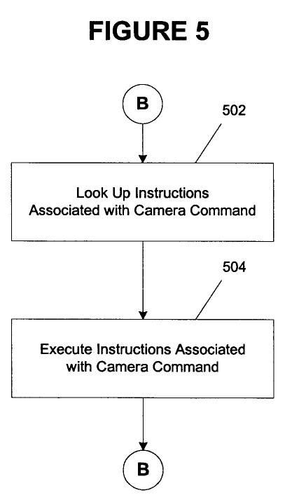

FIG. 5 is a flowchart describing a process for performing or executing a recognized camera command. This sub-process is spawned by the process described in box 314 of FIG. 3. The mobile phone's internal processor responsible for operating the camera function first looks up the instructions associated with the recognized camera command 502. The instructions are then executed 504 and control is returned to the wait state of box 310 in figure 3 to await another command.

Camera commands can relate to the settings and operation of the camera itself, or to the manipulation of an image taken by the camera. Commands pertaining to the former include, but are not limited to, setting the flash setting, setting the zoom, and taking the picture. Commands pertaining to the latter include, but are not limited to, deleting, storing, and/or sending the picture to one or more destinations/recipients. The user can set up groups or lists of recipients to send certain pictures. For instance, a picture of the user's child can be sent to other family members by invoking a command like ‘send to family’. A ‘family’ list has already been created and includes the requisite electronic address (or other means of contact) of each recipient, such as, but not limited to, an e-mail address, a multi-media messaging service (MMS) address for another mobile phone, or a web-site. The first part of the command, ‘send’, would invoke the mobile phone's message composition function. The ‘to family’ portion of the command instructs the phone to send the picture to each member in the family list. Once a message is composed and the picture attached, the mobile phone would attempt to automatically send the message using a data service that the mobile phone subscribes to. Message composition may also include adding or inserting text or audio. The text and/or audio can be predetermined and linked to a given command or the message composition can open a template or voice recording session in order to contemporaneously create text or audio content to accompany the picture being sent.

Standard text and audio messages could include phrases such as “Wish you were here”, “I'm running late”, etc. The user is free to compose stock text or audio phrases and attach them to commands.

Voice or audio control can be deactivated by the user when it is no longer desired. Deactivation of audio control is necessary so as not to perform camera functions unintentionally as well as saving battery power. Deactivation can be via an audible command such as ‘camera off’, by a key stroke (or set of key strokes) initiated by the user, or by a pre-set timeout period following the last executed command.

The present invention has been described with respect to audible control of a digital camera associated with a mobile phone. The present invention should not be construed as limited to audible control of a camera or camera accessory. Other media forms such as video and audio can be similarly audibly controlled in a mobile phone. Instead of using voice control to operate a camera, a mobile phone user can audibly operate an audio recording feature of the mobile phone allowing voice recordings of messages to be made. The mobile phone user can cause the mobile phone to make an audio recording using key words to begin and end the process. The recordings can then be attached to pictures to create multi-media messages that can be sent or e-mailed from the mobile phone.

Similarly, if the mobile phone is capable of capturing video as well as still images, voice control can be implemented to control the video functions. Commands such as ‘start shooting’ and ‘stop shooting’ can cause the mobile phone's video functions to record video during the time between the commands.

If a mobile phone supports multi-media audible control over image, video, and audio features, or any combination thereof, then additional database commands can be created to manage the multiple media formats. For instance, a message can be composed by attaching both an image and an associated audio recording. The user can issue commands such as, ‘open message template’, ‘address to family’, ‘attach image’, ‘attach audio recording’, and finally, ‘send message’. This sequence of commands would cause the mobile phone to create, compose, and send a multi-media message to a group of recipients defined by the user without having to manually enter any keystrokes.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. A combination mobile phone and digital camera comprising:
a processor;
a processor readable storage medium;
code recorded in the processor readable storage medium to enable audible control of a camera;
code recorded in the processor readable storage medium to compare detected audible signals to a database of commands for purposes of recognizing a command; and
code recorded in the processor readable storage medium to execute a series of instructions associated with a command that has been recognized.

2. The combination mobile phone and digital camera of claim 1 wherein the series of instructions comprises:
code recorded in the processor readable storage medium to take a picture.

3. The combination mobile phone and digital camera of claim 1 wherein the series of instructions comprises:
code recorded in the processor readable storage medium to compose a message;
code recorded in the processor readable storage medium to attach a picture to the message; and
code recorded in the processor readable storage medium to send the message.

4. The combination mobile phone and digital camera of claim 3 wherein the code recorded in the processor readable storage medium to compose a message comprises:
code recorded in the processor readable storage medium to address the message to one or more recipients; and
code recorded in the processor readable storage medium to insert text to the message.

5. The combination mobile phone and digital camera of claim 3 wherein the code recorded in the processor readable storage medium to compose a message comprises:
code recorded in the processor readable storage medium to address the message to one or more recipients; and
code recorded in the processor readable storage medium to attach audio to the message.

6. The combination mobile phone and digital camera of claim 3 wherein the message is an e-mail message.

7. The combination mobile phone and digital camera of claim 3 wherein the message is an MMS message.

8. The combination mobile phone and digital camera of claim 1 wherein the camera is integrated into the mobile phone.

9. The combination mobile phone and digital camera of claim 1 wherein the camera is attachable to the mobile phone as an accessory.

10. A combination mobile phone and digital camera comprising:
a microphone to detect audible input;
a database containing entries characterized as camera commands; and
a processor to:
process detected audible input;
compare detected audible input to the database of camera commands;
determine if the detected audible input matches one of the camera commands in the database; and
execute a series of instructions associated with a camera command that has matched a detected audible input.

11. The combination mobile phone and digital camera of claim 10 wherein the series of instructions comprises taking a picture.

12. The combination mobile phone and digital camera of claim 10 wherein the series of instructions comprises:
composing a message; and
attaching a picture to the message.

13. The combination mobile phone and digital camera of claim 12 wherein composing a message comprises:
addressing the message to one or more recipients; and
inserting text to the message.

14. The combination mobile phone and digital camera of claim 12 wherein composing a message comprises:
addressing the message to one or more recipients; and
attaching audio to the message.

15. The combination mobile phone and digital camera of claim 12 wherein the message is an e-mail message.

16. The combination mobile phone and digital camera of claim 12 wherein the message is an MMS message.

17. The combination mobile phone and digital camera of claim 10 wherein the camera is integrated into the mobile phone.

18. The combination mobile phone and digital camera of claim 10 wherein the camera is attachable to the mobile phone as an accessory.
